(19) United States
(12) Patent Application Publication
(10) Pub. No.: US 2002/0141935 A1
(43) Pub. Date: Oct. 3, 2002

(54) Process for producing hydrogen peroxide

(76) Inventors: Thomas Haas, Frankfurt (DE); Jurgen Glenneberg, Offenbach (DE); Rudolf Wagner, Grosskrotzenburg (DE); Rudolf Vanheertum, Brasschaat (BE)

Correspondence Address: SMITH, GAMBRELL & RUSSELL, LLP, 1850 M STREET, N.W., SUITE 800, WASHINGTON, DC, 20036, US

(21) Appl. No.: 10/105,619

(22) Filed: Mar. 26, 2002

(30) Foreign Application Priority Data
Mar. 27, 2001 (DE) 101 14 982.4

(51) Int. Cl. C01B 15/023

(52) U.S. Cl. 423/588

(57) ABSTRACT

Process for producing hydrogen peroxide The invention relates to a process for producing hydrogen peroxide by the cyclic anthraquinone process. According to the invention, the rate of oxidation of a hydrogenated working solution containing a tetrahydroanthrahydroquinone derivative is increased if the oxidation is carried out in the presence of a secondary amine. Preferably a slightly water-soluble secondary amine having a boiling point of at least 150° C., in a quantity of 0.001 to 2 mol per mol of tetrahydro compounds, is used.

### INTRODUCTION AND BACKGROUND

The present invention relates to a process for producing hydrogen peroxide by the so-called cyclic anthraquinone process, comprising a hydrogenation step, an oxidation step and an extraction step of a working solution containing a 2-alkyl substituted anthraquinone derivative, but in particular a tetrahydroanthraquinone derivative, as reaction carrier. The invention is directed in particular towards increasing the reaction rate of the oxidation step.

The so-called anthraquinone process is a large-scale process for producing hydrogen peroxide. This process comprises a catalytic hydrogenation of a working solution containing one or more anthraquinone derivatives, an oxidation step, wherein the hydrogenated working solution is oxidized by means of an oxygen-containing gas and an extraction step, wherein the hydrogen peroxide formed is extracted from the oxidized working solution using water or a dilute hydrogen peroxide solution. After the phase separation, the organic working solution is returned to the hydrogenation step. A survey of the chemistry and the technical carrying out of the anthraquinone process is given in Ullmann's Encyclopedia of Industrial Chemistry 5^{th} ed. (1989), Vol. A13, 447-45-7.

The working solution contains one or more solvents, whose task it is to dissolve both the anthraquinone derivatives serving as reaction carriers and the anthrahydroquinone derivatives formed during the hydrogenation. The anthraquinone derivatives are in particular 2-alkylanthraquinones and their tetrahydro derivatives, or 2-alkyl-5,6,7,8-tetrahydroanthraquinones. Both the alkylanthraquinones (abbreviated below as alkyl-AQ) and their tetrahydro derivatives (abbreviated below as alkyl-THAQ) take part in the cyclic process.

The oxidation step, in which the hydrogen peroxide is formed, is of great importance as regards the overall process and the economic efficiency of the process. In German Patent DE 1 104 493, the production capacity of the oxidation step is influenced to a considerable degree by the rate of oxidation of the anthrahydroquinone derivatives and in particular the 5,6,7,8-tetrahydroanthrahydroquinone derivatives contained in the hydrogenated working solution. Accordingly, many processes are directed towards carrying out the conversion of the 2-alkylanthrahydroquinones and 2-alkyltetrahydroanthrahydroquinones into the corresponding 2-alkylanthraquinones or 2-alkyltetrahydroanthraquinones as quantitatively as possible, minimizing the reactor volume and the energy input and suppressing the formation of secondary products, such as the epoxide of the 2-alkyl-tetrahydroanthraquinone derivatives.

A countercurrent oxidation process in a packed column is disclosed in U.S. Pat. No. 2,902,347. Because of the lower flooding limit, several columns have to be connected one behind the other. A combination of cocurrent and countercurrent procedures is disclosed in German publication DE-OS 2 003 268.

In the process according to EP 0 221 931 B1, the problems of the processes considered above can be lessened and the oxidation accelerated by passing a system with retarded coalescence, consisting of the hydrogenated working solution and an oxidizing gas, through a cocurrent reactor. Another cocurrent oxidation process is disclosed in German patent DE 40 29 784 C2. Here, a homogeneous dispersion of the hydrogenated working solution and the oxidizing gas is passed at a flow rate of 0.1 to 3 m/s through a reactor equipped with static mixing elements. It is proposed that the rate of oxidation be increased by using an alkaline-reacting, ionizable water-soluble inorganic compound as oxidation catalyst. Alkali metal hydroxides, alkaline-earth hydroxides, sodium carbonate and ammonium hydroxide are mentioned. The rate is indeed increased four to six times, but the tendency to emulsification caused by the oxidation catalyst renders it necessary to neutralize the alkaline compound prior to the extraction. The technical expense is thereby increased. At the same time, the input of chemicals and the content of inorganic salts in the aqueous H₂O₂ extract are increased. When this process was reproduced, it was found in addition that decomposition reactions occur to a considerable degree and hence the yield of H₂O₂ decreases correspondingly.

According to JP Patent 55-51843, tertiary amines having a pKa value of greater than 9, instead of alkaline-reacting inorganic compounds, are added as oxidation catalysts to the working solution. In addition, the solubility in water of the tertiary amine is reported to be low. The concentration of tertiary amine used is within the range of about 0.025 to 0.2 mol/l of the working solution. According to the examples, the relative rate of oxidation increases by a factor of 2.7 at the most; here triethylamine was used in a quantity of 0.086 mol/l.

It is therefore an object of the present invention to accelerate the oxidation step in the anthraquinone process, in particular in those processes wherein the reaction carrier contains a 2-alkyl-substituted tetrahydroanthraquinone derivative or 2-alkyltetrahydroanthrahydroquinone derivative (alkyl-THAHQ).

A further object of the present invention is to preferably increase the rate of oxidation to greater than that of the above-mentioned process using a tertiary amine.

### SUMMARY OF THE INVENTION

The above, and other objects of the present invention can be achieved by a process for producing hydrogen peroxide by the cyclic anthraquinone process, wherein a working solution, containing as reaction carrier one or more 2-alkyl substituted anthraquinone derivatives and/or tetrahydroanthraquinone derivatives (alkyl-AQ and alkyl-THAQ), is hydrogenated, the hydrogenated working solution is oxidized by means of an oxygen-containing gas and the oxidized working solution is extracted using water or an aqueous hydrogen peroxide solution. It is a feature of the invention that the oxidation is carried out in the presence of a secondary amine, preferably an aliphatic-aromatic secondary amine having at least 8 and in particular 12 to 36 C atoms. The secondary amine is preferably only slightly soluble in water.

Surprisingly, it was found that the action of the secondary amines as oxidation catalysts surpasses that of the tertiary amines at the same molar concentration. The quantity introduced can vary within wide ranges. The concentration of secondary amine is preferably within the range of 0.001 to 2 mol per mol of the sum of the tetrahydroanthraquinone derivatives and tetrahydroanthrahydroquinone derivatives contained in the working solution. The quantity introduced is particularly preferably within the range of 0.005 to 0.1 mol/mol of the sum of THAQ derivatives and THAHQ derivatives.

Whereas 2-alkylanthrahydroquinones are rapidly oxidized, the rate of oxidation of the corresponding tetrahydro derivative is considerably less. In the hydrogenation step, the conditions are exactly reversed. Accordingly, it is desirable to use a working solution containing at least one tetrahydroanthraquinone derivative in the anthraquinone process and, in the oxidation step, to increase the reaction rate by the presence of a secondary amine.

The alkyl group of the 2-alkyl-THAQ or 2-alkyl-THAHQ generally contains two to eight C atoms, these alkyl groups being unbranched or branched. The term alkyl, as used herein, denotes, for example, ethyl, i-propyl, n-propyl, n-butyl, sec.-butyl, n-amyl, sec.-amyl, tert.-amyl, n-hexyl, isohexyl, and 4-methyl-pentyl, n-octyl and 2,4-dimethylhexyl. The working solution preferably contains two different alkylanthraquinones and/or their tetrahydro derivatives.

The secondary amines may be aliphatic, cycloaliphatic, aromatic and aromatic-aliphatic amines. In so far as the amines have aliphatic substituents, these may be linear or branched. In the case of purely aliphatic secondary amines, the alkyl groups may be identical or different.

Examples of aliphatic amines are di-n-butylamine, di-n-hexylamine, di-n-octylamine, di-ndodecylamine, N-methyl-n-hexylamine, N-ethyl-n-octylamine, N-isopropyl-n-dodecylamine, N-ethylhexadecylamine, N-ethylstearylamine, distearylamine, dibenzylamine, N-nbutylbenzylamine.

Examples of aliphatic-aromatic amines are N-methylaniline, N-ethylaniline, Nisopropylaniline, N-benzylaniline, N-n-propylaniline, N-i-butylaniline, N-n-hexylaniline, N-methyl-ortho-, -meta- or -paratoluidine, N-isoamyl-toluidine, N-n-butylxylidine, N-octylnaphthalene. Aromatic secondary amines are, for example, diphenylamine, ditolylamine and di-2-naphthylamine.

The secondary amines to be used in the cyclic process are preferably only slightly water-soluble, in particular they have a solubility in water of less than 1%, in particular of less than 0.1%. To achieve this low solubility in water, the carbon number of at least one alkyl group of the aliphatic amines is at least 8 C atoms. Particularly preferably, aliphatic secondary amines contain 12 to 36 C atoms. The solubility in water of aromatic-aliphatic amines is generally lower than that of the purely aliphatic amines for the same average number of C atoms (7 to 12 C atoms).

Provided that water-soluble secondary amines in aqueous hydrogen peroxide do not interfere during the use of the latter, such an amine can also be used as catalyst. One example of a field of application for aqueous hydrogen peroxide containing catalytic quantities of a lower secondary amine is the production of propylene oxide by epoxidation of propene in the presence of a titanium-containing catalyst, such as titanium silikalit.

In contrast to secondary amines according to the invention, primary water-soluble amines are catalytically active, but a practical use is ruled out owing to their destructive effect on hydrogen peroxide.

Both water-soluble secondary amines, such as aliphatic amines having in total 2 up to about 8 C atoms, for example, diethylamine and dibutylamine, and slightly to substantially water-insoluble secondary amines are catalytically active. Whereas water-soluble amines to a greater extent enter the aqueous H₂O₂ phase during the extraction, for example, in the form of the phosphate salts, if phosphoric acid is used for the neutralization and stabilization, slightly water-soluble to insoluble secondary amines, hence those having average- or long-chain alkyl groups and/or aryl groups, remain substantially in the working solution. Amines which are sparingly soluble to insoluble in water contain at least 7 C atoms—examples are N-methylaniline or N-ethylaniline—but preferably at least 12 C atoms, for example, diphenylamine, N-n-butyl-n-octylamine, di-n-octylamine or dibenzylamine.

It has been found that higher-boiling water-insoluble secondary amines, even if they are used only in catalytic quantities, such as 1 g/l of working solution, fully retain their action as an oxidation catalyst even after repeated passage through the cyclic process.

It has also been found that secondary amines, in particular secondary amines having a boiling point of at least 150° C., preferably at least 180° C. and particularly preferably 200 to 300° C., are not only eminently suitable as oxidation catalysts, but are at the same time suitable as components of the solvent in the working solution. The above-mentioned high boiling point ensures that the discharge of solvent together with the waste gas from the oxidation is restricted. The quantity of secondary amine introduced as a component of the solvent may be varied within wide limits; the actual quantity introduced also depends on the rest of the solvents in the working solution. A suitable quantity introduced is within the range of about 1 to 30 wt. %, in particular 2 to 20 wt. %, in each case based on the working solution. The secondary amines are good solvents for the substituted anthraquinones and for the anthrahydroquinones as well as for their respective tetrahydro compounds.

The secondary amine is usefully added to the working solution and, together with this, introduced into the working solution. The secondary amine which is discharged together with the aqueous hydrogen peroxide and/or decomposed during the process or during a step involving regeneration of the working solution, or which has otherwise become ineffective, is replaced.

Preferably an amine which has a relatively low vapour pressure is used, so that this amine is not, or only to a small extent, discharged with the waste gas from the oxidation.

Although secondary amines having a higher number of C atoms are dissolved substantially in the organic phase during the oxidation and during the extraction, the amines may also, prior to or during the extraction, be converted by the addition of an acid, such as phosphoric acid or pyrophosphoric acid, into the salt and thereby transferred into the aqueous phase.

The oxidation step can in principle be carried out in an oxidation zone in a manner identical to that already described in prior art; the difference consists only in the presence of an effective quantity of an oxidation catalyst according to the invention. The oxidation is therefore carried out in one or more cocurrent or countercurrent columns. The columns may be free of baffles or/and packing or may contain such features.

In a preferred embodiment, a column containing finely perforated plates is used, and this is operated countercurrently—as in DE-A 198 43 673 which is relied on and incorporated herein by reference for its disclosure of the column. See also WO 00/17098 which is relied on and incorporated herein by reference.

In an alternative countercurrent embodiment, prior to entry into a baffle-free oxidation column, the hydrogenated working solution is mixed with an at least already partially oxidized working solution in order to suppress the formation of epoxides—see DE 001 25 715.3 which is relied on and incorporated herein by reference.

The oxidation reaction usually takes place at 30 to 70° C., in particular at about 40 to 60° C. The oxidizing gas is in most cases air, but air enriched with oxygen, as well as pure oxygen, can also be used.

The oxidation is followed by the known steps of extraction, purification, stabilization and concentration of the aqueous H₂O₂ phase, as well as regeneration and drying of the working solution. Afterwards, the working solution is again added to the hydrogenation step.

The hydrogenation step can, in known manner, be carried out in slurry reactors or in fixed-bed reactors. The hydrogenation is generally carried out in the presence of conventional free or supported precious metal catalysts or of catalysts fixed to the wall of the reactor. Regarding the details, composition of the working solution and the carrying out of the hydrogenation step and extraction, reference is made to prior art, including the survey in Ullmann's Encyclopedia cited above.

The essential advantage of the invention is the unexpectedly high increase in the rate of the oxidation reaction. Under certain conditions, the rate can be increased by more than a factor of 5 and mostly by up to a factor of about 10.

As a result of the increase in the rate, there is an increase in the space-time yield and therewith, at a given size of plant, in the production capacity. In order to ensure a given plant capacity, the plant can be made to smaller dimensions, whereby the capital costs and therewith the fixed costs can be lowered.

The invention is explained below by the Examples according to the invention and by Comparison Examples.

### EXAMPLES

### General Directions

The experiments were carried out in a heated glass flask. The stirrer speed was about 1000 rev/min. The volume of the glass flask was about 200 ml; the volume of working solution placed therein was 100 ml. Air was introduced into this solution at standard pressure. The working solution to be oxidized contained as solvent a mixture of 70 vol.% isodurene and 30 vol.% trioctyl phosphate and, as reaction carrier, 290 mmol tetrahydro-2-ethylanthrahydroquinone (THEAHQ) per kg of working solution. The reaction temperature was 50° C. The air flow was 50 Nl/h. During the reaction, samples were withdrawn and the H₂O₂ content after extraction with water was determined titrimetrically. At the end of the reaction, the H₂O₂ content was constant.

### Example 1

1000 ppm di-n-octylamine was added to the working solution. After 25 minutes, the solution was completely oxidized. The hydrogen peroxide formed was extracted with water. 95% of the theoretical quantity of hydrogen peroxide was recovered.

### Example 2

10% di-n-octylamine was added to the working solution. After a reaction time of 6 minutes, the solution was completely oxidized. The hydrogen peroxide formed was extracted with water. 95% of the theoretical quantity of hydrogen peroxide was recovered.

### Example 3

Water-soluble di-n-butylamine in a quantity of 1000 ppm, based on the working solution, was used as oxidation catalyst. The oxidation was completed within 10 minutes. The extraction was carried out using water containing a catalytic quantity of phosphoric acid (as stabilizer and for neutralization). The yield was virtually quantitative.

### Example 4

a) The working solution obtained after the oxidation and extraction in Example 1 was hydrogenated in known manner in a fixed bed reactor and subsequently oxidized and extracted. Following the method in PCT/EP 00/10532, it was hydrogenated using a trickle-bed procedure, the catalyst being Pd on Al₂O₃ and the LHSV value 40 h⁻¹. The entire cycle was repeated three times, during which the rate of oxidation and the H₂O₂ yield remained constant. No problems arose in the hydrogenation step either.

b) When the working solution from Example 2, in which dioctylamine was an important component of the solvent, was used, no problems were observed even after completion of three cycles of the anthraquinone process. Instead, the rate of hydrogenation and the rate of oxidation, as well as the yield of H₂O₂, remained consistently high.

### Comparison Example 1

A working solution was oxidized in the absence of an oxidation catalyst. After a reaction time of 90 minutes, the solution was completely oxidized.

### Comparison Example 2

100 ppm sodium hydroxide was added to the working solution. After a reaction time of 20 minutes, the solution was completely oxidized. However, after extraction with water containing phosphoric acid, less than 10% of the theoretical quantity of hydrogen peroxide could be recovered.

### Comparison Example 3

100 ppm ammonia was added to a working solution. After a reaction time of 20 minutes, the solution was completely oxidized. However, less than 10% of the hydrogen peroxide formed could be recovered.

### Comparison Example 4

1000 ppm 1,2-ethanediamine, i.e. a water-soluble primary amine, was added to the working solution. After a reaction time of 20 minutes, the solution was completely oxidized. However, only a small part of the hydrogen peroxide formed could be recovered.

Further variations and modifications of the foregoing will be apparent to those skilled in the art and are intended to be encompassed by the claims appended hereto.

German priority application 101 14 982.4 is relied on and incorporated herein by reference.

We claim:

1. A process for producing hydrogen peroxide by the cyclic anthraquinone process, comprising forming a working solution, containing as reaction carrier at least one of a 2-alkyl substituted anthraquinone derivative and a tetrahydroanthraquinone derivative (alkyl-AQ and alkyl-THAQ), hydrogenating said solution to obtain a hydrogenated working solution, oxidizing said hydrogenated working solution until an oxygen-containing gas in the presence of a secondary amine to form an oxidized working solution, extracting said oxidized working solution with water or an aqueous hydrogen peroxide solution.

2. The process according to claim 1, wherein the oxidation is carried out in the presence of an aliphatic, aromatic or aliphatic-aromatic secondary amine having at least 8 carbon atoms.

3. The process according to claim 1, wherein the oxidation is carried out in the presence of an aliphatic, aromatic or aliphatic-aromatic secondary amine having 12 to 36 carbon atoms.

4. The process according to claim 1, wherein the oxidation is carried out in the presence of 0.001 to 2 mol, of a secondary amine per mol of the tetrahydroanthraquinone derivatives and tetrahydroanthrahydroquinone derivatives (alkyl-THAQ+alkyl-THAHQ) contained in the working solution.

5. The process according to claim 2, wherein the oxidation is carried out in the presence of 0.001 to 2 mol, of a secondary amine per mol of the tetrahydroanthraquinone derivatives and tetrahydroanthrahydroquinone derivatives (alkyl-THAQ+alkyl-THAHQ) contained in the working solution.

6. The process according to claim 1, wherein the oxidation is carried out in the presence of 0.005 to 0.1 mol, of a secondary amine per mol of the tetrahydroanthraquinone derivatives and tetrahydroanthrahydroquinone derivatives (alkyl-THAQ+alkyl-THAHQ) contained in the working solution.

7. The process according to claim 2, wherein the oxidation is carried out in the presence of 0.005 to 0.1 mol, of a secondary amine per mol of the tetrahydroanthraquinone derivatives and tetrahydroanthrahydroquinone derivatives (alkyl-THAQ+alkyl-THAHQ) contained in the working solution.

8. The process according to claim 1 wherein the oxidation is carried out at a temperature within the range of 30 to 70° C.

9. The process according to claim 2 wherein the oxidation is carried out at a temperature within the range of 30 to 70° C.

10. The process according to claim 3 wherein the oxidation is carried out at a temperature within the range of 30 to 70° C.

11. The process according to claim 4 wherein the oxidation is carried out at a temperature within the range of 30 to 70° C.

12. The process according to claim 5 wherein the oxidation is carried out at a temperature within the range of 30 to 70° C.

13. The process according to claim 6 wherein the oxidation is carried out at a temperature within the range of 30 to 70° C.

14. The process according to claim 7 wherein the oxidation is carried out at a temperature within the range of 30 to 70° C.

15. The process according to claim 1, wherein the oxidation is carried out countercurrently in an oxidation zone.

16. The process according to claim 1, wherein the secondary amine has a boiling point of at least 150° C., and particularly is used as oxidation catalyst.

17. The process according to claim 1, wherein the secondary amine has a boiling point of at least 180° C., and particularly is used as oxidation catalyst.

18. The process according to claim 1, wherein the secondary amine has a boiling point of at least 200° C. to 300° C., and particularly is used as oxidation catalyst.

19. A process according to claim 1, wherein the secondary amine has a boiling point of at least 180° C. is used as oxidation catalyst and as a component of the solvent in the working solution, in a quantity of 1 to 30 wt. %, based on the working solution.

20. A process according to claim 1, wherein the secondary amine has a boiling point of at least 180° C. is used as oxidation catalyst and as a component of the solvent in the working solution, in a quantity of 2 to 20 wt. %, based on the working solution.
